(19) United States
(12) Patent Application Publication
(10) Pub. No.: US 2023/0266563 A1
(43) Pub. Date: Aug. 24, 2023

(54) PIEZOELECTRIC POINTING DEVICE

(71) Applicant: CEDRAT TECHNOLOGIES, Meylan (FR)

(72) Inventors: Gérald AIGOUY, Meylan (FR); Adrien GUIGNABERT, Meylan (FR); Etienne BETSCH, Meylan (FR); Augustin BEDEK, Meylan (FR); Nicolas BOURGEOT, Meylan (FR); Frank CLAEYSSEN, Meylan (FR)

(73) Assignee: CEDRAT TECHNOLOGIES, Meylan (FR)

(21) Appl. No.: 18/113,673

(22) Filed: Feb. 24, 2023

(30) Foreign Application Priority Data
Feb. 24, 2022 (FR) 2201629

(51) Int. Cl. G02B 7/182; G02B 26/08; H02N 2/02

(52) U.S. Cl. CPC G02B 7/182; G02B 26/0816; H02N 2/028

(57) ABSTRACT

A piezoelectric device comprises a fixed frame and a mirror carrier defining several support points securing a mirror. The mirror carrier is mounted rotatable. Several piezoelectric actuators are fixed to the support and deform independently in translation in a first direction. Each piezoelectric actuator moves the support area of the mirror carrier. The mirror carrier defines several attachment points. Each attachment point connects the mirror carrier mechanically with a piezoelectric actuator. The support points and attachment points are distinct from one another. The mirror carrier defines a plurality of flexion areas. The support points are movable with respect to one another. The piezoelectric actuators supplied in push-pull mode drive the support points making the mirror rotate perpendicularly to the first direction.

### BACKGROUND OF THE INVENTION

The invention relates to a piezoelectric pointing device.

### PRIOR ART

In the optical pointing field, it is known to use piezoelectric devices having a movable mirror. The mirror moves with rotations of limited travel to direct an optical beam or a laser beam. To move the mirror, piezoelectric actuators are used that are mechanically connected to the mirror so that deformation of the piezoelectric actuator results in rotation of the mirror in one or two directions perpendicular to a reference optical axis.

The applicant markets a tip-tilt piezoelectric mechanism illustrated in FIG. 1 that has a fixed frame 1 on which four piezoelectric actuators 2 are mounted to deform along four axes that are parallel to a first direction AA defined by the reference optical axis. The piezoelectric actuators 2 are each capped by a flexion shaft 3. The four flexion shafts 3 form a flexible mechanical link between the piezoelectric actuators 2 and a mirror carrier 4. The mirror carrier 4 is topped by a mirror 5. The strain axes of the actuators are arranged at equal distance from the centre of the circular mirror 5 used.

The mirror carrier 4 is manufactured very rigid so as not to deform with the effect of the stresses applied by the piezoelectric actuators 2 and retransmitted by the flexion shafts 3. The flexion shafts 3 are connected to an anchor stud 6 that is immobile. The anchor stud 6 is connected to the four flexion shafts 3 by means of a flexible bearing 7 that is formed by four straight flexors arranged in the form of a cross.

Flexible bearing 7 is flexible in first direction AA and stiff in the two directions perpendicular to the latter. Flexible bearing 7 increases the resistance to vibrations and shocks that may be encountered in particular in on-board applications. Finally, in combination with the flexion shafts 3, flexible bearing 7 contributes to transforming a translation of the peak of piezoelectric actuator 2 into a limited travel rotation of the peak of the flexion shaft 3.

The four piezoelectric actuators 2 work independently from one another. The flexion shafts 3 are mounted fixedly secured to piezoelectric actuator 2 and to the mirror carrier 4. To efficiently obtain a rotation with limited travel, it is conventional to supply the actuators in push-pull mode in pairs. Two actuators arranged diametrically opposite one another with respect to the reference optical axis passing through the centre of the mirror 5 are supplied so that one actuator expands while the other contracts.

In the configuration illustrated in FIG. 1, the mechanism has a first pair of actuators aligned in a direction B-B to produce a rotation around a direction C-C that is both perpendicular to direction A-A and perpendicular to direction B-B. The second pair of actuators formed by the actuators aligned in direction C-C produces a rotation around direction B-B.

It was observed that the piezoelectric device illustrated in FIG. 1 can generate wave front errors in use. These wave front errors were not always present and are caused by a deformation of the mirror 5 fixed on the mirror carrier 4. Such a teaching is presented in the document RU190404 where the mirror is fixed to a rigid mirror carrier having four actuation points located at the four corners of a rectangle. The four actuation points are fixed directly to four actuators so as to make the mirror tilt along two axes. The mirror carrier is secured to a deformable mounting plate by means of three pairs of screws arranged to form three aligned attachment points. The connection between the mirror carrier and the mounting plate is made in a first direction whereas the connection between the mounting plate and a fixed frame is made in a second direction perpendicular to the first direction. The deformable mounting plate enables the vibration frequency of the structure to be shifted to higher frequencies thereby improving the vibration resistance of the structure.

The document US 7,009,752 discloses a mirror support structure on which a mirror is fixed. The mirror support structure is connected to a reference plane by three actuators of voice coil actuator type that are arranged in a triangle and deform to make the mirror support structure tilt along two perpendicular axes. The three actuators are fixed directly to the mirror support structure that is rigid and supports the mirror. The mirror carrier is made from a material with a high rigidity, for example beryllium, whereas the mirror is made from glass covered by a reflective coating. As a complement to the actuators, the mirror support structure is fixed to the reference plane by flexible members that stress the tilt axes of the mirror.

Another configuration of a piezoelectric device is illustrated in the document FR2850218 or US6927528 and presents the same limitations.

The piezoelectric actuators 2 present a small travel which greatly limits the angular travel accessible to the mirror carrier 4. To produce a greater angular travel in a mechanism such as the one illustrated in FIG. 1, a trade-off has to be found as regards the size and cost of a piezoelectric actuator 2. This is generally expressed by the use of larger actuators 2, at the cost of a larger size and cost.

However, for pointing mechanisms, in addition to the above-mentioned constraints, a high angular travel is required to be obtained in a small volume with a minimum of parts in order to reduce the cost.

Another actuator of tip-tilt type is known that has an infinitely rigid mirror carrier and a mirror that is deformable on demand. The mirror is secured by means of several screws. An O-ring is placed between the mirror and the mirror carrier and is stressed between these two parts. The O-ring is elastically deformed in compression when the screws are clamped tight. Such a technical solution is disclosed in the document “Low order high accuracy deformable mirror based on electromagnetic actuators” by F.P. Wildi et al. Proceedings Volume 6715, Optomechatronic Actuators and Manipulation lll; 67150C (2007). The mirror is deformed by means of several magnets that are actuated by several magnetic fields.

### OBJECT OF THE INVENTION

One object of the invention consists in providing a piezoelectric device that limits undesirable deformations of the mirror so as to obtain a good optical quality.

These shortcomings tend to be solved by means of a piezoelectric device that comprises:
a fixed frame;
piezoelectric actuators fixed to the fixed frame, the piezoelectric actuators being able to deform independently from one another with a linear translation, each linear translation being directed in a first direction;
a mirror carrier defining attachment points and at least three support points, the at least three support points being designed to fixedly mount a mirror on the mirror carrier, the at least three support points being distinct from the attachment points, the at least three support points defining a support area mounted rotatable with respect to the fixed frame around at least a first rotation axis, the first direction being perpendicular to said at least first rotation axis, each attachment point being functionally connected to a piezoelectric actuator;
a converter arranged in at least one mechanical link connecting the piezoelectric actuators and the support points so that linear translation of one or more of the piezoelectric actuators results in rotation of the support area with respect to the fixed frame around said at least first rotation axis.

The piezoelectric device is remarkable in that at least one of the at least three support points is a support point mounted movable independently from the other support points in the first direction by elastic deformation of the mirror carrier, in the absence of the mirror.

Preferentially, each support point is a support point mounted movable independently from the other support points in the first direction by elastic deformation of a part of the mirror carrier, in the absence of the mirror.

According to one development, the device comprises a plurality of mounting plates, each support point being mounted on a mounting plate. Each mounting plate is fixed to the rest of the mirror carrier by a flexural link so that each mounting plate is mounted movable independently from the other mounting plates, in the first direction, in the absence of the mirror.

Preferentially, the support points are arranged at equal distance from a centre. The flexural links are arranged closer to the centre than the support points in an observation in the first direction.

Preferentially, the support points are arranged at equal distance from a centre. The support points are farther from the centre than the attachment points.

According to one development, the support points are arranged at equal distance from a centre. A top part of at least one of the piezoelectric actuators comprises a bar extending in a direction perpendicular to the first direction radially with respect to the centre so that the mechanical connection between the piezoelectric actuator and the associated attachment point is closer to the centre than to the piezoelectric bar of the piezoelectric actuator, in an observation in the first direction.

Preferentially, the mounting plates are configured to move in at least one direction perpendicular to the first direction.

In advantageous manner, the support points are arranged at equal distance from a centre. The flexural link is also configured to allow a radial movement of the support points perpendicularly to the first direction and with respect to the centre.

According to another development, the device comprises additional mounting plates. The centre is mounted fixedly with respect to the fixed frame by means of an anchor stud. Arms extend from the centre, each arm being fixed to one of the mounting plates by the flexural link, each arm being fixed to one of the additional mounting plates by a torsional link, the torsional link making the arm tilt with respect to the additional mounting plate around an axis perpendicular to the first direction, each additional mounting plate receiving an attachment point.

According to another development, the torsional link is arranged closer to the centre than the flexural link, along the extension direction of the arm from the centre to the opposite end.

In advantageous manner, the torsional link is arranged closer to the centre than the support point, in an observation in the first direction.

According to one development, the arms extend in the form of spiral turns.

Advantageously, the flexural link also defines a torsional link around an axis parallel to the first direction and passing through the flexural link.

Advantageously, the mirror carrier is fixed directly to at least one of the piezoelectric actuators so that the at least one attachment point moves with a linear translation in the first direction.

According to one development, each piezoelectric actuator is fixed directly to one of the attachment points, each attachment point belonging to an additional mounting plate that is more rigid than the arm on which the additional mounting plate is fixed by the torsional link.

Preferentially, each flexural link has a portion in the shape of an arc of a circle around the centre.

According to another development, the support points are arranged at equal distance from a centre. The centre is mounted fixedly with respect to the fixed frame by means of an anchor stud. The attachment points are connected to the piezoelectric actuators by a flexion shaft extending mainly in the first direction, one end of the flexion shaft being fixed to one of the actuators, the other end of the flexion shaft being fixed to one of the attachment points.

Advantageously, the mounting plates and the flexural links are defined by first slots that are pass-through in the first direction. In an observation in the first direction, each straight line connecting one of the support points to an attachment point straddles at least one of the first slots.

In preferential manner, the mirror carrier has second slots that are pass-through in the first direction and that extend in the form of spirals starting from the centre, the second slots separating the centre and the attachment points.

It is advantageous to provide for each support point to be arranged at equal distance from two of the attachment points that are closest.

Preferentially, the support points are arranged at equal distance from a centre. The centre is movable with respect to an anchor stud in the first direction. The converter has a flexible bearing having a fixed portion fixedly mounted with respect to the fixed frame by means of the anchor stud and flexors extending from the fixed portion in directions perpendicular to the first direction, the flexors being fixedly mounted to the attachment points. The piezoelectric actuators are connected to the attachment points by flexion shafts. The attachment points are mounted immobile with respect to one another in the mirror carrier.

In advantageous manner, the device comprises a mirror fixed to the mirror carrier by means of the support points, the mirror defining a mechanical connection with the support points that fixes the position of the at least one support point that is movable with respect to the other support points.

### DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 schematically illustrates a perspective view of a prior art piezoelectric device capped by a mirror;

FIG. 2 schematically illustrates a perspective view of an embodiment of a piezoelectric device including four piezoelectric actuators capped by a flexion shaft and a mirror carrier with deformable areas;

FIG. 3 schematically represents an exploded view of the piezoelectric device illustrated in FIG. 2;

FIG. 4 schematically represents a top view of the mirror carrier illustrated in FIG. 3;

FIG. 5 schematically represents a perspective view of another embodiment of a piezoelectric device including four piezoelectric actuators capped by a lever arm, a flexion shaft and a mirror carrier with deformable areas;

FIG. 6 schematically represents an exploded view of the piezoelectric device illustrated in FIG. 5;

FIG. 7 schematically represents a perspective view of a piezoelectric actuator the top part of which has an actuating arm offsetting a flexion shaft;

FIG. 8 schematically represents a view of a mirror carrier illustrated in FIG. 6 designed to support a mirror;

FIG. 9 schematically represents a perspective view of a third embodiment of a piezoelectric device capped by a mirror with a mirror carrier with deformable areas;

FIG. 10 schematically represents an exploded view of the piezoelectric device illustrated in FIG. 9;

FIG. 11 schematically represents a top view of a mirror carrier providing the mechanical link between the mirror, the piezoelectric actuators, and the anchor stud;

FIG. 12 schematically represents another embodiment of a mirror carrier that can be used as replacement for the mirror carrier illustrated in FIG. 8;

FIG. 13 schematically represents another embodiment of a mirror carrier that can be used as replacement for the mirror carrier illustrated in FIG. 8;

FIG. 14 schematically represents yet another embodiment of a mirror carrier that can be used as replacement for the mirror carrier illustrated in FIG. 8;

FIG. 15 schematically represents yet another embodiment of a mirror carrier that can be used as replacement for the mirror carrier illustrated in FIG. 8 for the purpose of using a mirror assembled by bonding;

FIG. 16 schematically represents the mirror carrier of FIG. 15 assembled with a bonded mirror.

### DESCRIPTION OF THE EMBODIMENTS

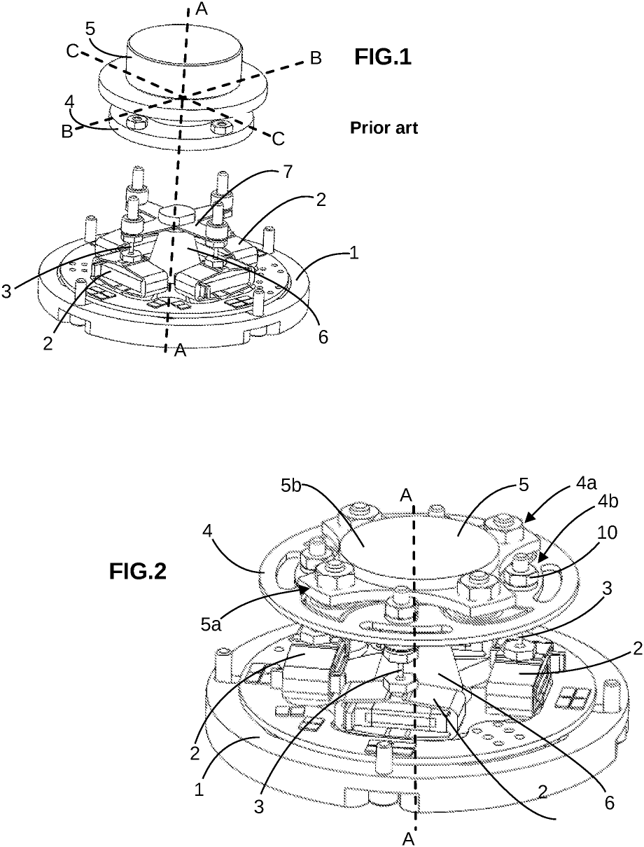

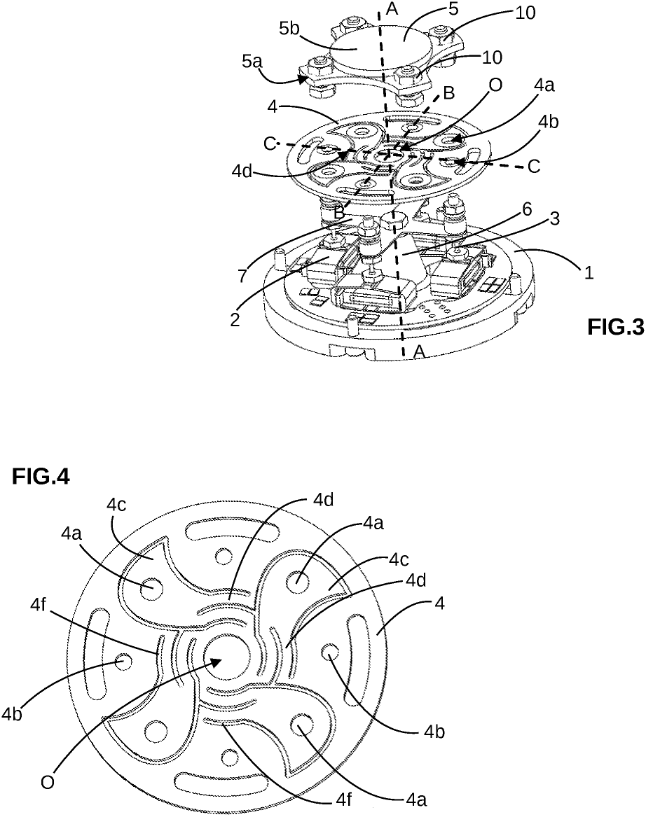

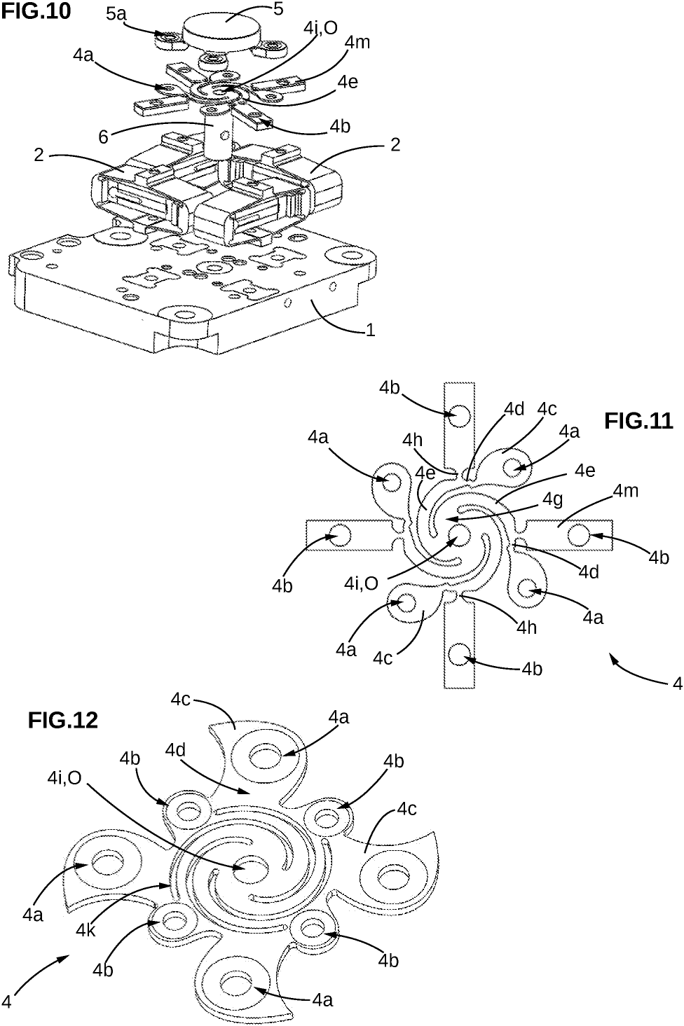

Different configurations of piezoelectric devices are illustrated in FIGS. 2 to 16. A piezoelectric device has a fixed frame 1 that acts as support and that has a first surface capped by several piezoelectric actuators 2, preferably at least two piezoelectric actuators 2, even more preferentially at least three non-aligned piezoelectric actuators 2 or even four or at least four non-aligned piezoelectric actuators 2. The piezoelectric actuators 2 are secured to the fixed frame 1. In the different illustrated embodiments, four piezoelectric actuators 2 are used.

The piezoelectric actuators 2 are secured to the fixed frame 1 and extend from one surface of the fixed frame 1. The piezoelectric actuators 2 are able to deform independently from one another with a linear translation. Each linear translation is directed along an axis that is parallel to a first direction AA. The piezoelectric actuators 2 are connected to a control circuit configured to actuate the piezoelectric actuators and preferentially able to actuate the latter independently from one another.

The piezoelectric device has a mirror carrier 4 designed to receive and support a mirror 5. The mirror 5 is mounted removable with respect to the mirror carrier 4. The mirror carrier 4 provides the mechanical link between the piezoelectric actuators 2 and the mirror 5. The mirror carrier 4 is an interface part between the mirror 5 and the piezoelectric actuators 2. The mirror carrier 4 defines several support points 4a designed to fixedly mount the mirror 5. The support points 4a define a support area of the mirror carrier 4. The support area of the mirror carrier 4 is mounted rotatable around at least a first rotation axis BB with respect to the fixed frame 1 so that the mirror 5 is mounted rotatable around said at least first rotation axis BB that is perpendicular or substantially perpendicular to first direction AA. Preferably, the support area of the mirror carrier 4 is configured so that the mirror 5 is also mounted rotatable around a second rotation axis CC that is perpendicular to first direction AA and perpendicular to first rotation axis BB. The support points 4a of the mirror carrier 4 collaborate with support points 5a of the mirror 5. The mirror carrier 4 has at least three support points 4a to efficiently secure the mirror 5 on the mirror carrier 4, preferably at least four support points 4a. Once the mirror 5 is secured to the mirror carrier 4, the mirror 5 follows the same movements as the support area.

The mirror carrier 4 defines several attachment points 4b, preferably at least three attachment points, for example four attachment points 4b. The support points 4a are distinct from the attachment points 4b. Each piezoelectric actuator 2 is mechanically associated with an attachment point 4b via a direct or indirect mechanical link so that actuation of piezoelectric actuator 2 moves the associated attachment point 4b. The mechanical connection between piezoelectric actuator 2 and the mirror carrier 4 is a connection that enables the mirror carrier 4 to be pushed or pulled to make the mirror 5 rotate in one direction or the other according to the direction of deformation of piezoelectric actuator 2.

Each piezoelectric actuator 2 is mechanically connected to the mirror carrier 4 so that deformation of piezoelectric actuator 2 shifts an attachment point 4b which moves the support area of the mirror carrier 4 with respect to the fixed frame 1 to obtain a rotation component around first rotation axis BB and possibly second rotation axis CC. Actuation of the piezoelectric actuators 2 acts on the mirror carrier 4 and results in rotation of the support area and therefore rotation of the mirror 5. The attachment points 4b move with respect to the frame according to the stress applied by the piezoelectric actuators 2.

As illustrated in the different figures, the mirror carrier 4 can be removable with respect to the fixed frame 1.

The piezoelectric device comprises a converter that is configured to convert the linear translations originating from the deformations of the piezoelectric actuators 2 into at least a rotation of the support area with respect to the fixed frame 1. The converter can be formed by elements that are distinct from the mirror carrier 4 and/or areas of the mirror carrier 4. The converter can be formed by one or more parts. The converter can be distinct from the mirror carrier 4 or monolithic with the mirror carrier 4. Different configurations of converter are illustrated in FIGS. 2 to 16. When the converter is distinct from the mirror carrier 4, the converter is preferentially fixed directly to the mirror carrier 4 as illustrated. As illustrated, the converter is not fixed directly to the mirror 5 when the converter is distinct from the mirror carrier 4.

The piezoelectric device comprises an anchor stud 6 that is mounted fixedly on the fixed frame 1. The anchor stud 6 extends in first direction AA. The anchor stud 6 can be used to fixedly mount a part of the mirror carrier 4 and/or elements of the converter with respect to the fixed frame 1. The anchor stud 6 can be removable or unremovable from the fixed frame 1.

The inventors observed that, in devices of the prior art, a part of the deformations present in the mirror 5 after the latter has been mounted on the mirror carrier 4 are due to the hyperstatism introduced by the fixing of the mirror 5 on the mirror carrier 4. Due to the manufacturing tolerances, support points 5a of the mirror 5 are in fact never strictly at the same exact position as the support points 4a, in particular in direction AA. The divergence as regards the dimensions results in stresses in the mirror 5 when the latter is fixed rigidly on the mirror carrier 4.

When the mirror 5 is fixed to the mirror carrier 4 by four support points 4a, the configuration is by definition hyperstatic, and an unevenness in the support points 4a of the mirror carrier 4 and/or in support points 5a of the mirror 5 results in stresses being generated when fixing takes place. As the mirror carrier 4 is much more rigid than the mirror 5, the stresses are mainly introduced in the mirror 5 which deforms.

In a configuration with three support points 4a and three support points 5a, a hyperstatism situation also arises as the support points 4a/5a are not pin-point. The support points are more or less large surfaces. When the surfaces of the support points 4a and 5a do not define the same plane, stresses are introduced when fixing is performed that deform the mirror 5.

Unlike the rigid mirror carrier of the prior art, different configurations of a deformable mirror carrier 4 are proposed. The mirror carrier 4 has at least one of the support points 4a mounted movable in first direction AA by deformation of a part of the mirror carrier 4, preferably by elastic deformation of the mirror carrier 4. One of the support points 4a is mounted movable independently from the other support points 4a in order to better match the position of the support points 4a of the mirror carrier 4 with the position of support points 5a of the mirror 5 thereby reducing the stresses introduced in the mirror 5.

It is particularly advantageous for at least two support points 4a to be mounted movable independently from one another and with respect to one another so as to better match the positions of support points 5a. The two support points 4a can be mounted movable in first direction AA. In even more preferential manner, each support point 4a is mounted movable independently from the others at least in first direction AA. It is then easier to adjust the position of the support points 4a and 5a concomitantly to match one another.

Support point or points 4a are mounted movable independently from one another when the mirror 5 is not secured. When the mirror 5 is secured, the support points 4a become fixed with respect to one another.

Movement of the support points 4a with respect to one another takes place by elastic deformation of the mirror carrier 4, for example by means of a spring linkage or by means of an elastically deformable washer arranged between a support point 4a of the mirror carrier 4 and a support point 5a of the mirror 5. Deformation of the spring or washer makes for a better adjustment. However, this configuration proves not to be the most advantageous as it requires the insertion of an additional part which may be a source of error when assembly is performed.

In particularly advantageous manner, the support point 4a, the support points 4a or each support point 4a are mounted movable with respect to the rest of the mirror carrier 4 by means of a mounting plate 4c secured by a flexural link 4d. Such a configuration enables easy adjustment between the support points 4a and support points 5a with an automatic and adjusted adaptation.

When the mirror 5 is fixed to the mirror carrier 4, the support points 4a move until they come into contact with support points 5a thereby adjusting to the configuration of the mirror 5. The mirror 5 is then mounted fixedly on the mirror carrier 4. The mirror 5 moves in accordance with the movements of the support points 4a. In the illustrated embodiments, direction AA passing through centre O of the mirror carrier 4 is identical to the direction of the optical axis of the mirror 5 when the latter is in its rest position, i.e. when the piezoelectric actuators 2 are not stressed, as represented in FIG. 2 or FIG. 5.

The flexural link 4d deforms elastically which enables the position of the support points 4a of the mirror carrier 4 to be matched with the position of support points 5a of the mirror 5. The shape of the mounting plate 4c and/or of the flexural link 4d are to be judiciously selected to best match the stresses of the mirror 5. In the case of a flat mirror, this ensures that the planarity of its reflecting surface 5b is preserved resulting in a reduction of wave front errors.

After it has been fixed, the mirror 5 defines a more rigid mechanical link between the different support points 4a of the mirror carrier 4. The mirror 5 limits the mobility of the support points 4a. In this way, the behaviour of the mirror carrier 4 is different depending on whether the mirror 5 is fixed or not fixed to the mirror carrier 4. Support point or points 4a which are initially movable with respect one another become fixed with respect to one another. The position of the support points 4a of the mirror carrier 4 is defined by the mirror 5 to adjust the dimensional divergences. Once it has been secured to the mirror carrier 4, the mirror 5 is able to tilt around first rotation axis BB and/or second rotation axis CC according to the strains applied on the piezoelectric actuators 2, in identical or substantially identical manner to a prior art mirror carrier such as the one illustrated in FIG. 1.

The use of a flexurally-movable mounted the support point 4a also enables a support point to be achieved that is movable with respect to the attachment points 4b. The flexural link 4d incorporated in the mechanical link connecting the support point 4a to the attachment point 4b enables a part of the vibrations to be filtered and the mechanical integrity of the mirror 5 against shocks and vibrations induced by the fixed frame 1 to be better preserved.

Different configurations of the support points 4a that are movable with respect to one another and movable with respect to the attachment points 4b are illustrated in FIGS. 2 to 14.

The use of a mirror carrier 4 that is deformable goes against the teachings of the prior art which propose an infinitely rigid mirror carrier 4 to ensure a good efficiency of the piezoelectric actuators 2. The use of a mirror carrier 4 that is deformable enables a mirror carrier 4 to be formed that is thinner and therefore less heavy than those of the prior art. The gain in weight to be moved enables the size of the piezoelectric actuators 2 and the electrical consumption to be reduced.

The inventors also observed that in devices of the prior art, a part of the deformations develops in the mirror 5 when temperature variations occur. This deformation is due to the expansion difference between the mirror carrier 4 and the mirror 5 that are made from different materials comprising different expansion coefficients. When temperature variations occur, the rigid mirror carrier 4 of the prior art expands more than the mirror and imposes its deformation on the mirror 5 which is more flexible and deforms.

To form the mounting plates 4c mounted flexurally movable in a mirror carrier 4 in the form of a plate, it is advantageous to use first slots 4f. In a particular embodiment illustrated in FIGS. 2 to 8, the mirror carrier 4 has the mounting plates 4c each having a support point 4a. The mounting plates 4c are terminated by the flexural link 4d that secures the mounting plate 4c to the rest of the mirror carrier 4. The shapes of the mounting plates 4c and of the flexural links 4d are defined by the first slots 4f that pass through the mirror carrier 4 in direction AA. The shape and position of the first slots 4f define the deformation allowed for each flexural link 4d and therefore the possible displacement for each support point 4a in first direction AA.

In the illustrated embodiment, the first slots 4f that define the mounting plates 4c and the flexural links 4d for the support points 4a are in the form of a cut-out passing round each support point 4a except for the flexural link(s) 4d to maintain the mechanical link.

As illustrated in FIGS. 4, 8, 13, 14 and 15, it is particularly advantageous to define the first slots 4f that separate each support point 4a from the other support points 4a, observation being made by drawing a straight line between each pair of two support points 4a movable independently from one another. It is also advantageous to define the first slots 4f in such a way that they separate each support point 4a and centre O of the mirror carrier 4 as illustrated in FIG. 4, observation being made by drawing a straight line between each support point 4a and centre O. It is also advantageous to define the first slots 4f that separate each support point 4a and its two closest attachment points 4b when an imaginary straight line is drawn between the support point 4a and the attachment point 4b considered.

Unlike the rigid mirror carrier of the prior art, different deformable mirror carrier configurations are also proposed enabling mirror support points to be obtained that are movable in direction AA and also in directions BB and CC, to enable the mirror support to expand in directions BB and CC without deforming the mirror when temperature variations occur.

To form a deformable mirror carrier 4, it is advantageous to use a mirror carrier 4 in the form of a plate. The dimension of the plate is much larger along rotation axes BB and CC than in direction AA, for example at least five times larger or at least 10 times larger. In preferential manner, the mirror carrier 4 is formed by a metal plate of small thickness, preferably less than 3 mm, preferentially less than 2 mm and even more preferentially less than 1 mm. The small thickness of the plate enables the weight of the mirror carrier 4 to be reduced. By reducing the weight of the mirror carrier 4, a reduced force applied by piezoelectric actuator 2 is required to make the mirror carrier 4 rotate.

In order to reduce the deformations induced in the mirror 5 more efficiently, it is advantageous to reduce the introduction of stresses due to the differential expansion between the mirror 5 and the mirror carrier 4 as far as possible. It is advantageous for at least one support point 4a to be movable with respect to the other support points 4a in a direction perpendicular to first direction AA. Preferentially at least two or even all of the support points 4a are movable independently from one another in at least one direction perpendicular to first direction AA.

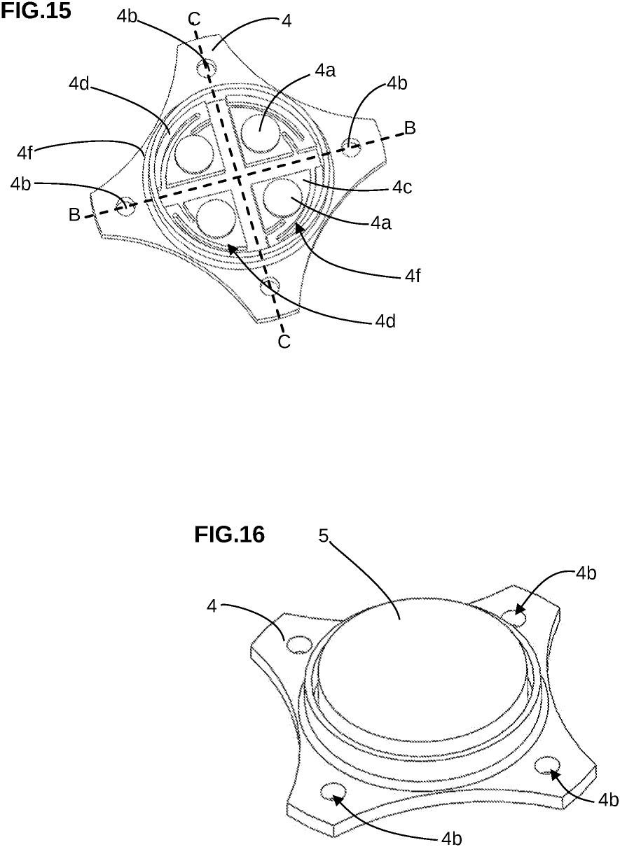

In a particular embodiment illustrated in FIG. 15, the mounting plates 4c receiving the support points 4a are mounted movable in first direction AA by means of the first slots 4f. It is advantageous for the first slots 4f to enable movement of the support points 4a to be had in directions BB and CC. In the embodiment illustrated in FIG. 15, the support points 4a are designed to provide bonding surfaces to secure a mirror 5, illustrated in FIG. 16.

It is also advantageous for the mobility of the support point 4a in the at least one direction perpendicular to first direction AA to be obtained by elastic deformation of the mirror carrier 4 for the mirror carrier 4 to adjust continuously and automatically to the position of support point 5a according to the change of temperature. Such a configuration of the mirror carrier 4 makes it easier to adjust to problems of hyperstatism and/or differential expansion.

It is advantageous for the support points 4a to be arranged at equal distance from a centre O of the mirror carrier 4. More preferentially, the support points 4a are arranged regularly along an imaginary circle passing through all the support points 4a and centre O to better compensate differential expansions. An offset exists that is equal to 90° when the four support points 4a are used or equal to 120° for the three support points 4a. This configuration is illustrated in FIGS. 2 to 16.

In such a configuration, in order to better master the position of the mirror 5 with respect to the mirror carrier 4 and the stresses induced when temperature changes occur, it is preferable for the mounting plate 4c to also move with a radial component. The flexural link 4d and/or the mounting plate 4c allow movement of the support point 4a with a radial component. For example, according to FIG. 4, the flexural link 4d extends in the form of an arc of a circle around centre O. As an alternative or as a complement, the mounting plate 4c comprises cut-outs in the shape of an arc of a circle around centre O. When a temperature change occurs, the differential expansion applies stresses on the cut-outs which are deformed. With such cut-outs, the support points 4a and support points 5a move slightly in a radial direction perpendicularly to direction AA and passing through centre O. This enables the planarity of the mirror 5 to be better preserved and wave front errors to be reduced, over a wider temperature range.

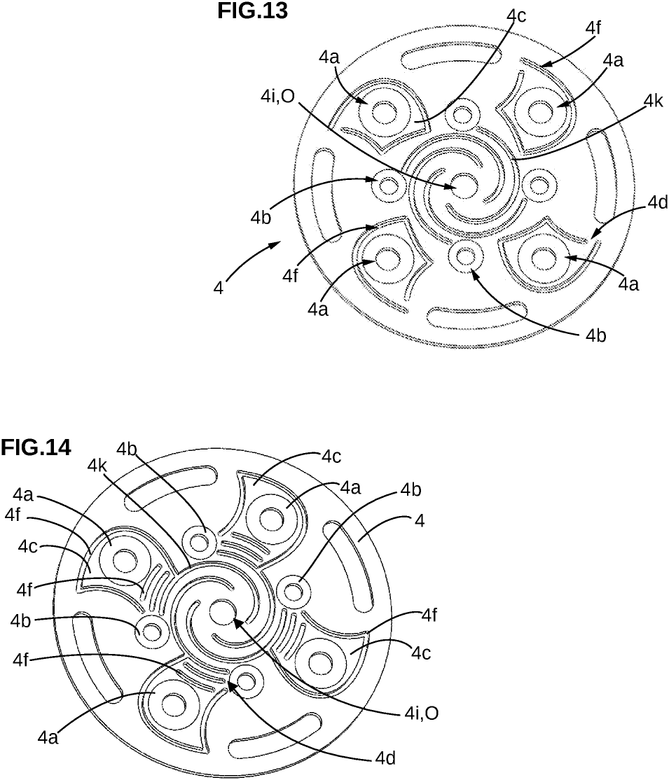

Different configurations are possible to define a movement of a support point 4a with the radial component. FIG. 4 illustrates a mounting plate 4c with a flexural area 4d fixing the mounting plate 4c to the rest of the mirror carrier 4 that is in the form of an arc of a circle of centre O. Preferentially, the multiple mounting plates 4c have equivalent arcs of a circle, i.e. with the same radius, the same centre and the same angular arc. FIGS. 13, 14 and 15 present other configurations of the mirror carrier 4 where the conformation of the mounting plate 4c associated with the conformation of flexural area 4d enables a radial movement of the support point 4a to be easily obtained when it is fixed to the mirror 5. For example, the flexural link 4d illustrated in FIG. 8 can be modified to form a flexural link 4d in the shape of an arc of a circle as illustrated in FIG. 14.

FIGS. 9 to 11 present another embodiment with a mounting plate 4c mounted on an arm 4e extending in the form of a spiral from centre O and having a flexural link 4d that also allows a torsion in a plane perpendicular to first direction AA to enable the support point 4a to move radially in relation with the deformation of spiral arm 4e that supports the mounting plate 4c. The arm 4e extends mainly in a plane perpendicular to first direction AA, preferably in at least one direction.

In preferential manner, at least a first flexural link 4d is formed by a plurality of the first slots 4f that define arcs of a circle around centre O of the mirror carrier 4. Such first slots 4f enable a flexural link 4d to be formed with a radial component as defined in the foregoing.

It is also advantageous for the two first slots 4f, serving the purpose of defining a flexural link 4d for a support point 4a, to originate from the same kerf, i.e. to correspond to the continuation of the same cut in the material. It is also advantageous for an arc of a circle to be in cutting line continuity with at least one arc of a circle, preferably with two arcs of a circle of the adjacent flexural link 4d. Such a configuration makes for a better mastery of the flexion and enables a torsional strain to be introduced for the mounting plate 4c.

It is preferable for the flexural link(s) 4d associated with each support point 4a to be located closer to centre O of the mirror carrier 4 than the corresponding support point 4a, when observed in first direction AA as illustrated in FIGS. 4, 8, 11, 12, 13 and 14. The distance is measured in a straight line between centre O and the support point 4a. Such a configuration results in movement of the support points 4a being more suitable for compensating the differential expansion. However, a reverse configuration is possible and even preferable when the mirror 5 is of large size, for example when it extends beyond the mirror carrier 4 as illustrated in FIGS. 13 or 15.

In a preferential embodiment illustrated in FIGS. 8, 12, 13 and 14, support points 4a are arranged farther from centre O of the mirror carrier 4 than the attachment points 4b when observed in first direction AA, in radial manner. In this way, movement of the attachment points 4b produced by the piezoelectric actuators 2, preferably in push-pull mode, generates a greater angular travel of the mirror 5 than if this same movement was applied on the support points 4a. Smaller actuators 2 can thus be used than those that would be necessary for actuation of the support points 4a. There is therefore an advantage in having the attachment points 4b as close as possible to centre O of the mirror carrier 4 to have as large an amplitude of rotation as possible for the mirror 5. The embodiment illustrated in FIG. 4 represents the attachment points 4b that are farther from centre O than the support points 4a, but it is possible to use a reverse configuration.

However, the closer attachment points 4b are to centre O, the more the piezoelectric actuators 2 have to be compact so as to be able to be installed in a small volume, for a fixed deformation in direction AA in order to obtain a large rotation of the mirror carrier 4.

To increase the amplitude of rotation of the support area for a predefined translation of one or more of the piezoelectric actuators 2, it is advantageous to place the attachment points 4b as close as possible to centre O of the mirror carrier 4 or to the central axis parallel to direction AA and passing through centre O. However, if the configuration in which the piezoelectric actuators 2 are in the extension of the attachment points 4b in direction AA is kept, this means moving the piezoelectric actuators closer to one another therefore giving rise to a congestion problem for installation of the piezoelectric actuators 2.

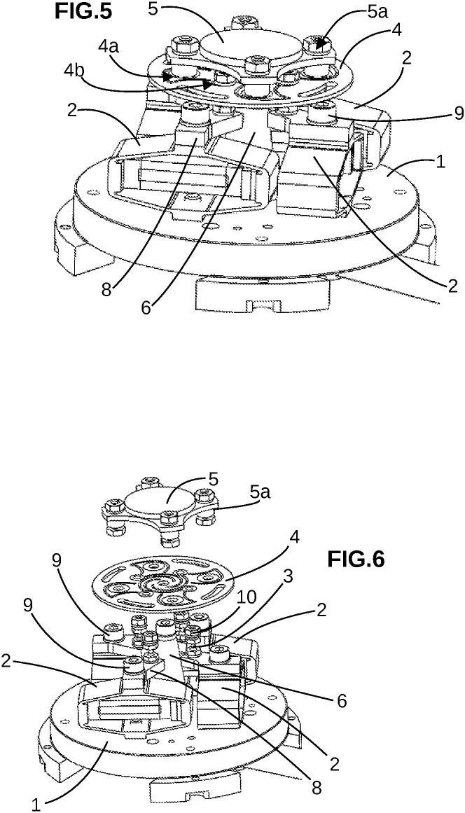

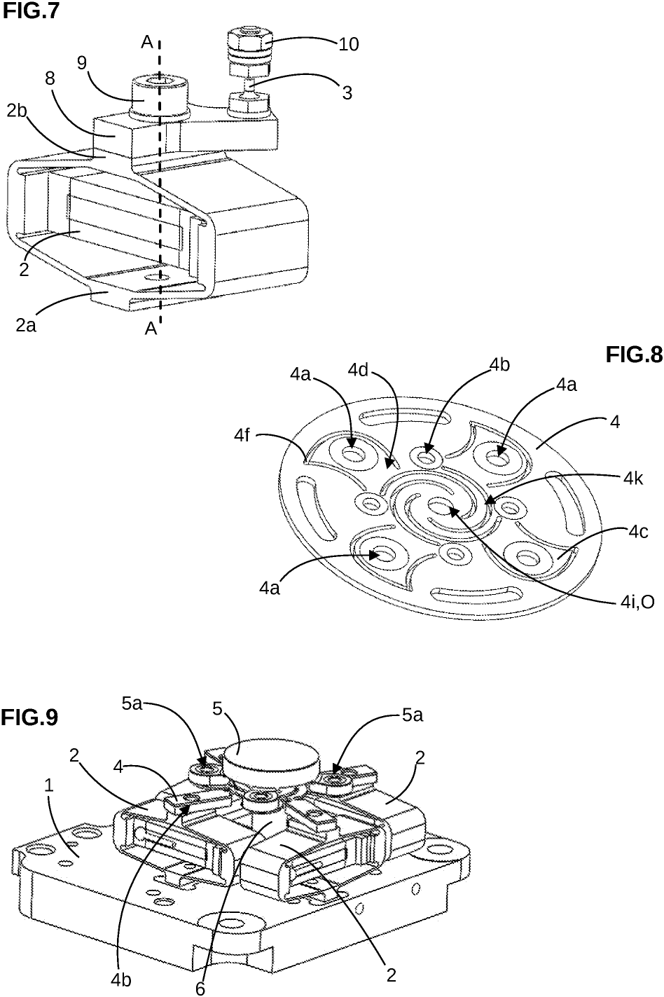

It is particularly advantageous to provide for at least one of the piezoelectric actuators 2 and preferentially all of the piezoelectric actuators 2 to be capped by a bar 8 fixed to the top part of piezoelectric actuator 2 as illustrated in FIG. 7 and in the piezoelectric device presented in FIGS. 5 and 6. The bar 8 extends perpendicularly to first direction AA and in radial manner with respect to the central axis. The bar 8 moves in first direction AA in identical manner to the movement produced by the deformation of piezoelectric actuator 2 in first direction AA. The bar 8 is rigid so as to limit its flexion and thereby maintain a high efficiency on the rotation of the mirror 5. The end of the bar 8 closest to centre O can be fixed directly or indirectly to the mirror carrier 4 according to the configurations. In the particular embodiment illustrated in FIG. 7, the offset end of the bar 8 is capped by a flexion shaft 3. The first end of the flexion shaft 3 is secured to the bar 8 by a fixing device, for example a screw 9, and the second end of the flexion shaft 3 is secured to the attachment point 4b, for example by a screw.

FIGS. 5 and 6 illustrate an embodiment using the piezoelectric actuators 2 equipped with bars 8 directed towards the centre of the structure. An equivalent technical solution can be applied in the embodiment illustrated in FIG. 2 or in the one illustrated in FIG. 9. This enables larger the piezoelectric actuators 2 to be used without encountering a congestion problem in proximity to the anchor stud 6.

The attachment points 4b receive the mechanical stresses originating from the piezoelectric actuators 2. In order to achieve a good control of the rotation angle of the mirror 5 for a predefined translation of a piezoelectric actuator 2, it is advantageous to have a mechanical link with flexion areas 4d of the support points 4a that is rigid, and preferably as rigid as possible between the attachment points 4b. The rigid mechanical link is configured so that the attachment points 4b are mounted immobile with respect to one another or substantially immobile with respect to one another.

In a particular embodiment illustrated in FIGS. 2 to 8, the mirror carrier 4 is in the form of a plate the outline of which defines a disk or a convex polygon. The external peripheral area of the plate is continuous and connects all the attachment points 4b continuously to form a mechanical link that is as rigid as possible without making the mirror carrier 4 too heavy. This configuration enables the attachment points 4b that are immobile or almost immobile with respect to one another to be formed easily and with a small extra weight.

As an alternative illustrated in FIG. 12, the mirror carrier 4 can be devoid of the rigid peripheral area. The attachment points 4b are secured fixedly to one another by other means, for example a localised thickening of the mirror carrier 4. FIG. 12 reverts back substantially to the shape of the mirror carrier 4 of FIG. 4, the peripheral area having been eliminated.

In another embodiment, the mirror carrier 4 is in the form of a plate devoid of a continuous annular peripheral portion and the attachment points 4b are arranged movable with respect to one another. In this embodiment, to efficiently take advantage of the forces applied by the piezoelectric actuators 2, it is preferable to have as many support points 4a as the attachment points 4b. The mirror carrier 4 comprises several flexurally movable arms 4e and each arm 4e has a mounting plate 4c with its support point 4a and an attachment point 4b as illustrated in FIGS. 9 to 11.

In the embodiment illustrated in FIGS. 9 to 11, the mirror carrier 4 has an anchor point 4i mounted immobile with respect to the fixed frame 1. The anchor point 4i can be mounted fixedly by means of the anchor stud 6. It is particularly advantageous for the anchor point 4i to be the centre O for ease of manufacture of the mirror carrier 4 and use of the piezoelectric device. The arms 4e extend from the anchor point 4i and are flexurally movable from the anchor point 4i at least in first direction AA. Each attachment point 4b is fixed to a piezoelectric actuator 2. In preferential manner, the attachment point 4b is fixed directly to a piezoelectric actuator 2 to be biased in translation in direction AA. The arm 4e is mounted flexurally by means of a flexing link 4 g.

In order to achieve a greater efficiency, the attachment point 4b is formed on an additional mounting plate 4 m that is very rigid. The additional mounting plate 4 m can be locally reinforced to increase its stiffness in comparison with the arm 4e. It is possible to provide a larger thickness of the material forming the mirror carrier 4 or to add a rigid part by welding, bonding, screw-fastening, riveting or any other suitable technique to limit deformation of the additional mounting plate 4 m in comparison with the arm 4e in first direction AA. The additional mounting plate is connected to the arm 4e by a deformable mechanical link 4h preferably a torsional link to facilitate flexural movement of the arm 4e and a linear translation in direction AA of the attachment point 4b.

The support point 4a is connected to the arm 4e by the flexural link 4d. The attachment point 4b is connected to the arm 4e by the deformable mechanical link 4h. The two links 4d and 4h work in their elastic deformation range. The two links 4d and 4h ensure that the support points 4a are movable with respect to one another (in the absence of the mirror) and that the attachment points 4b are movable with respect to one another. The two links 4d and 4h ensure that, for an arm 4e, the attachment point 4b is movable with respect to the support point 4a. The mobility between the attachment points 4b enables a hyperstatism originating from the piezoelectric actuators 2 to be better accommodated. Slight differences of height (in first direction AA) are compensated by the mirror carrier 4 without preventing or limiting the angular range of the mirror carrier 4 in its rotations. A better accommodation of the hyperstatism enables dimensional constraints regarding manufacture on the piezoelectric actuators 2 to be relaxed thereby reducing manufacturing costs.

The support points 4a and the attachment points 4b are movable with respect to the anchor point 4i. The arms 4e are flexible and deform according to the stress imposed by each piezoelectric actuator 2. Stressing of an attachment point 4b by a piezoelectric actuator 2 results in movement of the attachment point 4b and therefore in movement of the flexibly mounted arm 4e. This causes the support point 4a to move and makes the mirror 5 tilt.

It is particularly advantageous to form the flexural link 4d and the mechanical link 4h by localised thinning.

In a particular embodiment, flexural area 4d is located after the mechanical link 4h, along the extension direction of arm 4e from the anchor point 4i towards the opposite end. This configuration is advantageous as it enables a larger angular offset of a support point 4a to be had in comparison with the reverse configuration or with direct actuation on the support point 4a. In even more advantageous manner, the torsional link 4h is arranged closer to centre O than the flexural link 4d, along the extension direction of arm 4e from centre O to the opposite end. It is preferable for the torsional link 4h to be arranged closer to centre O than the support point 4a of the same arm, when observed in first direction AA. The distance is measured in a straight line.

In an advantageous embodiment, the arms 4e extend in the form of spirals away from the anchor point 4i. The shape of the arms 4e in portions of spiral enables their effective length connecting the anchor point 4i to the attachment points 4b to be increased so as to increase the angular range accessible for rotation of the mirror 5.

This embodiment is particularly advantageous as it enables the mirror carrier 4 to be secured directly to the piezoelectric actuators 2 and to an anchor stud 6 and also enables the mirror 5 to be secured directly to the mirror carrier 4. As the mirror carrier 4 can be in the form of a plate, this makes it possible to achieve a more compact configuration than the configurations of the prior art in first direction AA and also a less heavy configuration and with less parts.

The embodiment illustrated in FIGS. 9 to 11 enables the piezoelectric actuators 2 to be easily moved farther away from centre O thereby reducing the congestion constraints linked to integration of the multiple piezoelectric actuators 2. The attachment points 4b extend from the spiral-shaped arms 4e in radial directions away from centre O. To keep a high efficiency of rotation, it is preferable for additional mounting plate 4 m that comprises the attachment point 4b up to the mechanical link 4h to be very rigid so that the linear translation applied by piezoelectric actuator 2 is substantially identical between mechanical link 4a and piezoelectric actuator 2.

It is advantageous for the mirror carrier 4 to have an axial symmetry with an axis of symmetry parallel to first direction AA. It is also advantageous for the mirror carrier 4 to present a rotational symmetry, for example with a 90° or 120° rotation.

It is advantageous to use four piezoelectric actuators 2 instead of three piezoelectric actuators 2 as this facilitates control of the rotation of the mirror carrier 4 around two rotation axes BB and CC.

The piezoelectric actuators 2 deform to define a linear translation between a first end 2a and a second end 2b. The linear translation is observed in first direction AA. First end 2a is mounted fixedly on the fixed frame 1, and deformation of second end 2b is a linear translation that is mainly oriented in first direction AA. Deformation of piezoelectric actuator 2 is expressed by a movement between first end 2a and second end 2b towards or away from one another in first direction AA. Different configurations of the piezoelectric actuators 2 are possible, but it is advantageous to use the configurations described in the documents US6927528 and FR2740276. The piezoelectric actuator has a bar made from piezoelectric material. Use of the bar enables the actuation point to be moved closer to centre O than to the piezoelectric bar in an observation in first direction AA.

A converter transforming the linear translation of second end 2a into a rotation of one of the support points 4a can be obtained in different ways. In the embodiments illustrated in FIGS. 2 to 6, a flexion shaft 3 connects a piezoelectric actuator 2 and an attachment point 4b. The flexion shaft 3 is configured to deform flexurally thereby transforming the translational movement of second end 2a into a rotation of the associated attachment point 4b. To achieve the rotational movement easily, the attachment point 4b is also fixed to a flexor in the form of an arm one end of which is fixedly mounted on the attachment point 4b and the other end of which is fixedly secured to the fixed frame 1, preferably to the anchor stud 6. Preferentially, this assembly is repeated for each piezoelectric actuator 2. Flexors can be mounted together in the form of a part forming a flexible bearing 7. In the embodiment illustrated in FIGS. 2 to 4, the mirror carrier 4 is not fixed directly to the fixed frame 1. In this embodiment, the converter is formed by the flexible bearing 7 and the flexion shafts.

In another embodiment illustrated in FIGS. 5 to 8, the flexion shafts 3 connect the piezoelectric actuators 2 and the attachment points 4b. An anchor portion 4i also forming centre O of the mirror carrier 4 immobilises centre O with respect to the fixed frame 1. In this embodiment where the flexors are not used, it is preferable to structure the mirror carrier 4 to make it more flexible than in the configuration illustrated in FIG. 2 thereby better adjusting the incline of the attachment point 4b to the deformation of the flexion shaft 3. It is particularly advantageous to form through second slots 4k such as cut-outs extending in the form of spirals from anchor area 4i to the attachment points 4b. The through second slots 4k in the form of spirals reduce the flexural stiffness of the mirror carrier between the attachment points 4b and the anchor point 4i.

Finally in another embodiment illustrated in FIGS. 9 to 11, the converter is integrally formed in the mirror carrier 4 so that actuators 2 can be secured directly to the mirror carrier 4.

Advantageously, the piezoelectric actuators 2 are amplified piezoelectric actuators based on a piezoelectric stack and an amplifying casing having a second end 2b screw-fastened to an attachment point 4b.

In the embodiment illustrated in FIG. 7, piezoelectric actuator 2 has a bar 8 mounted removable and secured by means of a screw 9. In the embodiment illustrated in FIGS. 9 to 11, the screw 9 is designed to screw into end 2b of piezoelectric actuator 2 to secure the mirror carrier 4 on piezoelectric actuator 2. The screw 9 passes through the hole forming the attachment point 4b. FIGS. 2, 3, 5 and 6 illustrate the use of a bolt 10 to secure the mirror 5 on the mirror carrier 4. The bolts 10 can be used for the embodiment of FIGS. 9 to 11. In the embodiments illustrated in FIGS. 2 to 7, the flexion shaft 3 is terminated by a threaded section associated with at least one nut to secure the mirror carrier 4 to the end of the flexion shaft 3.

The support points 4a and the attachment points 4b ensure the formation of a mechanical link with the mirror carrier 4. They can have smooth or threaded through holes, threaded non-through holes, threaded salient areas, flat surfaces designed for bonded links, or any other means of securing with the mirror carrier 4. It is advantageous to use bolts to secure the different parts in order to ensure a good mechanical strength in response to external vibrations. In the illustrated embodiments, the attachment points 4b and the support points 4a have through holes in the mirror carrier 4 for example for a screw or bolt 10 to pass through.

In preferential manner, the piezoelectric actuators 2 are associated in pairs and the piezoelectric actuators 2 of a pair are arranged in opposite manner with respect to a first direction AA passing through the centre of the support area and of the mirror 5 if the latter is present. It is advantageous to associate piezoelectric actuator 2 in opposite pairs by the control circuit so as to produce a push-pull mode designed to produce a rotational movement with limited travel of the mirror carrier 4 and the mirror 5. This mode is obtained by supplying power to the two piezoelectric actuators 2 of the opposite pair with respect to direction AA so that one piezoelectric actuator 2 expands while the other contracts.

It is advantageous to arrange the two attachment points 4b aligned along a rotation axis BB and to align the two other attachment points 4b along another rotation axis CC perpendicular to the previous axis. To tilt the support area around rotation axis BB, the two piezoelectric actuators 2 associated with the two attachment points 4b aligned along axis CC are actuated in opposite directions along direction AA. One contracts and the other expands. To tilt the support area around rotation axis CC, the two piezoelectric actuators 2 associated with the two attachment points 4b aligned along axis BB are actuated in opposite directions along direction AA. One contracts and the other expands.

In a configuration with three piezoelectric actuators, it is preferable to stagger the actuators regularly, i.e. with an angular offset equal to 120° all around axis AA passing through the centre of the support area. It is also advantageous to place the attachment points 4b at equal distance from axis AA passing through the centre of the support area and to use identical actuators. An advantageous use of the push-pull mode is possible by applying a command on each actuator of a pair of close neighbouring actuators such that their travel is opposite and equal to half of the amplitude of the travel of the remaining actuator. The centre of the mirror is aligned with the centre of the support area in direction AA.

Deformation of the one or more piezoelectric actuators 2 with a linear translation in direction AA, for example in push-pull mode, results in displacement of one or more attachment points 4b inducing a rotation of the mirror carrier 4 by means of the converter. This rotation moves the support area and therefore the support points 4a with respect to the fixed frame 1. The mirror 5 moves in rotation as it is immobile or almost immobile with respect to the mirror carrier 4. Introducing a flexibility in the mirror carrier 4 via the support points 4a that are movable with respect to one another means that the forces introduced by the piezoelectric actuators 2 are not or almost not applied to the inside of the mirror 5 thereby limiting deformation of the mirror 5 without preventing control of the rotation.

The piezoelectric device is designed for optical pointing applications such as optical communication in free space, designation, scanners, laser machining or laser surgery. This involves on-board applications or applications in harsh environments encountered in the space, optronics, aeronautical, defence, industrial or medical sector.

1. Piezoelectric pointing device comprising:
a fixed frame;
piezoelectric actuators fixed to the fixed frame, the piezoelectric actuators being able to deform independently from one another with a linear translation, each linear translation being directed in a first direction;
a mirror carrier designed to receive and support a mirror and to provide the mechanical link between the piezoelectric actuators and the mirror, the mirror carrier defining attachment points and at least three support points, the at least three support points being designed to fixedly mount a mirror on the mirror carrier, the at least three support points being distinct from the attachment points, the at least three support points defining a support area mounted rotatable with respect to the fixed frame around at least a first rotation axis, the first direction being perpendicular to said at least a first rotation axis, each attachment point being functionally connected to a piezoelectric actuator;
a converter arranged in at least one mechanical link connecting the piezoelectric actuators and the support points so that linear translation of one or more of the piezoelectric actuators results in rotation of the support area with respect to the fixed frame around said at least a first rotation axis;
wherein the mirror carrier is in the form of a plate defining the attachment points and the at least three support points and wherein the mirror carrier is deformable so that at least one of the at least three support points is a support point mounted movable independently from the other support points in the first direction by elastic deformation of the mirror carrier, in the absence of the mirror.

2. Piezoelectric pointing device according to claim 1, wherein each support point is a support point mounted movable independently from the other support points in the first direction by elastic deformation of a part of the mirror carrier, in the absence of the mirror.

3. Piezoelectric pointing device according to claim 2, comprising a plurality of mounting plates, each support point being mounted on a mounting plate, wherein each mounting plate is fixed to the rest of the mirror carrier by a flexural link so that each mounting plate is mounted movable independently from the other mounting plates in the first direction, in the absence of the mirror.

4. Piezoelectric pointing device according to claim 3, wherein the support points are arranged at equal distance from a centre and wherein the flexural links are arranged closer to the centre than the support points in an observation in the first direction.

5. Piezoelectric pointing device according to claim 1, wherein the support points are arranged at equal distance from a centre and wherein the support points are farther from the centre than the attachment points.

6. Piezoelectric pointing device according to claim 1, wherein the support points are arranged at equal distance from a centre and wherein a top part of at least one of the piezoelectric actuators comprises a bar extending in a direction perpendicular to the first direction radially with respect to the centre so that the mechanical connection between the piezoelectric actuator and the associated attachment point is closer to the centre than to the piezoelectric bar of the piezoelectric actuator, in an observation in the first direction.

7. Piezoelectric pointing device according to claim 3, wherein the mounting plates are configured to move in at least one direction perpendicular to the first direction.

8. Piezoelectric pointing device according to claim 7, wherein the support points are arranged at equal distance from a centre and wherein the flexural link is also configured to allow a radial movement of the support points perpendicularly to the first direction and with respect to the centre.

9. Piezoelectric pointing device according to claim 8, comprising additional mounting plates, wherein the centre is mounted fixedly with respect to the fixed frame by means of an anchor stud, and wherein arms extend from the centre, each arm being fixed to one of the mounting plates by the flexural link, each arm being fixed to one of the additional mounting plates by a torsional link, the torsional link making the arm tilt with respect to the additional mounting plate around an axis perpendicular to the first direction, each additional mounting plate receiving an attachment point.

10. Piezoelectric pointing device according to claim 9, wherein the torsional link is arranged closer to the centre than the flexural link, along the extension direction of the arm from the centre to the opposite end.

11. Piezoelectric pointing device according to claim 9, wherein the torsional link is arranged closer to the centre than the support point, in an observation in the first direction.

12. Piezoelectric pointing device according to claim 9, wherein the arms extend in the form of spiral turns.

13. Piezoelectric pointing device according to claim 12, wherein the flexural link also defines a torsional link around an axis parallel to the first direction and passing via the flexural link.

14. Piezoelectric pointing device according to claim 9, wherein the mirror carrier is directly fixed to at least one of the piezoelectric actuators so that the at least one attachment point moves with a linear translation in the first direction.

15. Piezoelectric pointing device according to claim 14, wherein each piezoelectric actuator is fixed directly to one of the attachment points, each attachment point belonging to an additional mounting plate that is more rigid than the arm on which the additional mounting plate is fixed by the torsional link.

16. Piezoelectric pointing device according to claim 8, wherein each flexural link has a portion in the shape of an arc of a circle around the centre.

17. Piezoelectric pointing device according to claim 3, wherein the support points are arranged at equal distance from a centre, wherein the centre is movable with respect to an anchor stud in the first direction, wherein the converter has a flexible bearing having a fixed portion mounted fixedly with respect to the fixed frame by means of the anchor stud and the flexors extending from the fixed portion in directions perpendicular to the first direction, the flexors being mounted fixedly to the attachment points, wherein the piezoelectric actuators are connected to the attachment points by flexion shafts and wherein the attachment points are mounted immobile with respect to one another in the mirror carrier.

18. Piezoelectric pointing device according to claim 17, wherein the mounting plates and flexural links are defined by first slots that are pass-through in the first direction and wherein, in an observation in the first direction, each straight line connecting one of the support points to an attachment point straddles at least one of the first slots.

19. Piezoelectric pointing device according to claim 3, wherein the support points are arranged at equal distance from a centre and wherein the centre is mounted fixedly with respect to the fixed frame by means of an anchor stud, and wherein the attachment points are connected to the piezoelectric actuators by a flexion shaft extending mainly in the first direction, one end of the flexion shaft being fixed to one of the actuators, the other end of the flexion shaft being fixed to one of the attachment points.

20. Piezoelectric pointing device according to claim 5, wherein the mirror carrier has second slots that are pass-through in the first direction and that extend in the form of spirals from the centre, the second slots separating the centre and the attachment points.

21. Piezoelectric pointing device according to claim 1, wherein each support point is arranged at equal distance from two of the attachment points that are closest.

22. Piezoelectric pointing device according to claim 1, comprising a mirror fixed to the mirror carrier by means of the support points, the mirror defining a mechanical connection with the support points that fixes the position of the at least one support point that is movable with respect to the other support points.
